(19) United States
(12) Patent Application Publication
(10) Pub. No.: US 2010/0178916 A1
(43) Pub. Date: Jul. 15, 2010

(54) METHOD AND SYSTEM FOR NOTIFYING AVAILABILITY OF FEMTOCELLS TO AN ELECTRONIC DEVICE

(75) Inventor: Satish Nanjunda Swamy JAMADAGNI, Bangalore (IN)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/686,114

(22) Filed: Jan. 12, 2010

(30) Foreign Application Priority Data
Jan. 12, 2009 (IN) 93/CHE/2009

(51) Int. Cl. H04W 28/16; H04W 84/02

(52) U.S. Cl. 455/434; 455/449

(57) ABSTRACT

A method and system for notifying the availability of femtocells to an electronic device are provided. The method includes determining a fingerprint for each of the femtocells by a base station of a macrocell. The method also includes maintaining fingerprints of the femtocells by the base station. The method further includes notifying the availability of the femtocells to the electronic device based on corresponding fingerprints. The system includes a macrocell. The system also includes the femtocells in vicinity of the macrocell. The system further includes the electronic device that receives notification of the availability of the femtocells. Moreover, the system includes a base station in the macrocell to notify the availability of the femtocells to the electronic device.

### PRIORITY

This patent application claims priority under 35 U.S.C. §119(e) to Indian Patent Application filed in the Indian Patent Office on Jan. 12, 2009 and assigned Serial No. 93/CHE/2009, and on Dec. 4, 2009 and assigned Serial No. 93/CHE/2009, the contents of which are incorporated herein by reference.

### BACKGROUND OF THE INVENTION

1. Field of the Invention

The present invention relates generally to the field of wireless communication, and more particularly, to a method and system for notifying the availability of femtocells to an electronic device.

2. Description of the Related Art

A macrocell is a cell that provides radio coverage within a mobile network. When an electronic device, for example a mobile phone, enters the macrocell, the electronic device scans for one or more femtocells in vicinity of the macrocell. Therefore, battery power is wasted due to measuring inaccessible femtocells and due to background searching for femtocells that may not exist. Further, there is also a waste of measurement bandwidth of the femtocells to which a mobile station of the electronic device does not subscribe. In an existing solution to this problem, the electronic device can store a map between a femtocell and its corresponding macro cell ID and when in the region of the macro cell coverage can send a list including one or more identifiers of the femtocells to the macro cell/base station that the electronic device can be attached to, in order to request any additional information, for example frequency in case of a dedicated frequency femtocell deployment. Such a procedure is tedious and time consuming. This solution has drawbacks, as there is no opportunity to access open access cells and hybrid cells. Further, if the femtocell membership of an electronic device changes, there is no way to obtain the femtocell according to the macro cell ID mapping (called the finger print).

In light of the foregoing discussion, there is a need for a method and system for efficiently notifying the availability of femtocells to an electronic device.

### SUMMARY OF THE INVENTION

Embodiments of the present disclosure described herein provide a method and system for notifying the availability of femtocells to an electronic device.

An example of a method for notifying the availability of femtocells to an electronic device includes determining a mapping between the femtocell of interest to a given electronic device and a macro cell ID, the coverage area within which the femtocell is available (called the fingerprint) for each of the femtocells by a base station of a macrocell. The method also includes determining and maintaining a mapping between an electronic device, its membership to a femtocell and the corresponding macro cell under which the coverage of the femtocell can be found. The method also includes maintaining such fingerprints of the femtocells by the base station including the fingerprint of open and hybrid femtocells.

The method further includes notifying the availability of the femtocells to the electronic device based on corresponding fingerprints.

An example of a system for notifying the availability of femtocells to an electronic device includes a macrocell. The system also includes femtocells in the vicinity of the macrocell. The system further includes the electronic device that receives notification of the availability of the femtocells. Moreover, the system includes a base station in the macrocell to notify the availability of the femtocells to the electronic device.

### BRIEF DESCRIPTION OF THE DRAWINGS

In the accompanying figures, similar reference numerals may refer to identical or functionally similar elements. These reference numerals are used in the detailed description to illustrate various embodiments and to explain various aspects and advantages or the present invention. In the drawings:

FIG. 1 illustrates a block diagram of an environment for notifying the availability of femtocells to an electronic device, in accordance with an embodiment of the invention;

FIG. 2 is a schematic diagram of a system for notifying the availability of femtocells to an electronic device, in accordance with an embodiment of the invention; and

FIG. 3 illustrates a flowchart of a method for notifying the availability of femtocells to an electronic device, in accordance with an embodiment of the invention.

Persons skilled in the art will appreciate that elements in the figures are illustrated for simplicity and clarity and may have not been drawn to scale. For example, the dimensions of some of the elements in the figures may be exaggerated relative to other elements to help to improve understanding of various embodiments of the present disclosure.

### DETAILED DESCRIPTION OF THE PREFERRED EMBODIMENTS

It should be observed that method steps and system components have been represented by conventional symbols in the figures, showing only specific details that are relevant for an understanding of the present disclosure. Further, details that may be readily apparent to person ordinarily skilled in the art may not have been disclosed. In the present disclosure, relational terms such as first and second, and the like, may be used to distinguish one entity from another entity, without necessarily implying any actual relationship or order between such entities.

Embodiments of the present disclosure described herein provide a method and a system for notifying the availability of femtocells to an electronic device.

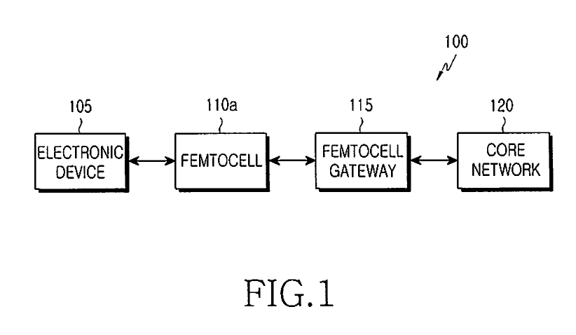

FIG. 1 illustrates a block diagram of an environment 100 for notifying the availability of femtocells to an electronic device 105, in accordance with an embodiment of the invention. The environment 100 includes the electronic device 105 in communication with one of the femtocells, for example a femtocell 110a, to obtain one or more services. Examples of the services include, but are not limited to, a call service and a message service. Examples of the femtocell 110a include, but are not limited to, a Long Term Evolution (LTE) femtocell, a Worldwide interoperability for Microwave Access (WiMAX) femtocell, a Universal Mobile Telecommunication System (UMTS) femtocell, and a WiFi femtocell. The femtocell 110a provides a service by communicating with a core network 120 of the electronic device via a femtocell gateway 115. The femtocell gateway 115 aggregates femtocell traffic and routes the femtocell traffic in accordance with a type of the service. Examples of the core network 120 include, but are not limited to, Global System for Mobile communications (GSM) Edge Radio Access Network (GERAN), Universal Mobile Telecommunication System (UMTS) Terrestrial Radio Access Network (UTRAN), an LTE network, and a WiMAX network.

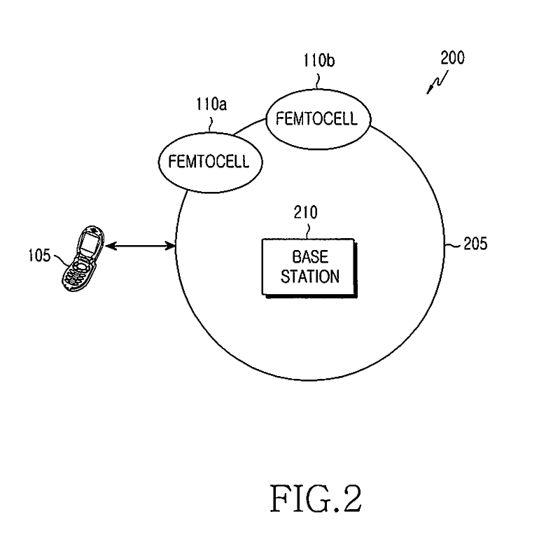

FIG. 2 illustrates a schematic diagram of a system 200 for notifying the availability of femtocells to an electronic device 105, in accordance with an embodiment of the invention. Examples of the electronic device 105 include, but are not limited to, a cellular device, a Personal Digital Assistant (PDA), a laptop, and a personal computer. The system 200 also includes one or more femtocells, for example, a femtocell 110a and a femtocell 110b within a macrocell 205. Examples of the femtocells include, but are not limited to, closed subscriber group cells, open access cells, and hybrid cells. A closed subscriber group cell is a cell that includes a set of subscribers authorized by a femtocell owner/network service provider. An open access cell can be accessed by any electronic device without authorization. A hybrid cell requires authorization for specific electronic devices. The system 200 also includes a base station 210 within the macrocell 205 that notifies the availability of one or more femtocells to the electronic device 105, if the electronic device 105 enters the macrocell 205. The base station 210 determines a fingerprint for each of the femtocells to notify the electronic device 105. The fingerprint is a mapping between a femtocell identifier, for example a closed group identifier of a closed subscriber group cell, a physical cell identifier, and a macro cell identifier.

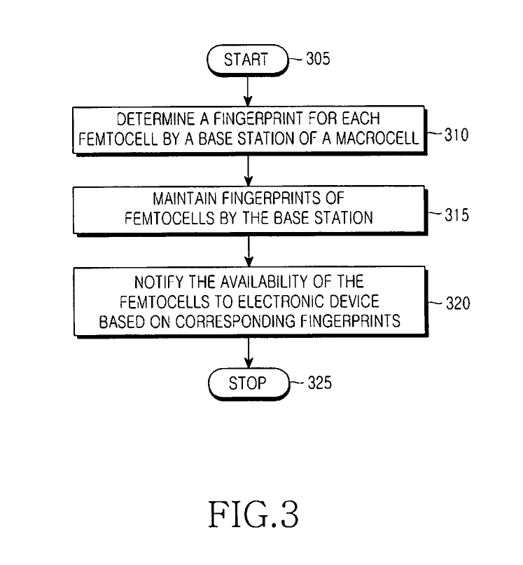

FIG. 3 illustrates a flowchart of a method for notifying the availability of femtocells to an electronic device, in accordance with an embodiment of the invention. The femtocells are at least one of a closed subscriber group cell, an open access cell, and a hybrid cell.

The method starts at step 305.

At step 310, a fingerprint is determined for each of the femtocells by a base station of a macrocell. The fingerprint can include a mapping between a femtocell identifier, for example a closed group identifier of a closed subscriber group cell, a physical cell identifier, and a macro cell identifier. The base station creates the fingerprint of each of the femtocells.

In one embodiment, the electronic device 105 reports the fingerprint in a measurement report to the base station 210. In another embodiment, a presence of the femtocells within a range of the macrocell is reported by the electronic device 105 to the base station 210.

In one embodiment the femtocells within the coverage area of a macro cell can be configured by the network operator and the base station, and the base station further constructs the fingerprint after obtaining an association between an electronic device and the subscribed femtocell, from a home subscriber server.

In some embodiments, the base station 210 extracts the fingerprint from the association between the electronic device and the subscribed femtocell, from the home subscriber server.

At step 315, one or more fingerprints (i.e., a mapping between an electronic device identifier, femtocells and the corresponding macro cell identifier) are maintained by the base station 210. The base station 210 maintains an association between the macro fingerprint and the identifiers of the femtocells.

In some embodiments, the fingerprint of a femtocell can be associated with one or more electronic devices that have permission to access services through the femtocell.

In some embodiments, the base station can dynamically associate open and hybrid cell identifiers with the fingerprint associated with one or more electronic devices.

At step 320, the base station 210 notifies the availability of the femtocells based on corresponding fingerprints to the electronic device 105. The base station 210 can notify the availability using one or more control channels. A control channel can be a page message when the electronic device 105 is in an idle mode. The control channel can be one of a Slow Dedicated Control CHannel (SDCCH), a Slow Associated Control CHannel (SACCH) and a Packet Associated Control CHannel (PACCH) when the electronic device 105 is in a connected mode. In a case of hybrid cells, a core network 120 of the electronic device 105 can dynamically alter membership information associated with the hybrid cells to allow control of access for the electronic device 105 to hybrid cells. The base station 210 can temporarily use the open access cells or the hybrid cells to handle any load issues or increased interference issues among the femtocells.

The base station 210 can also provide temporary access for the closed subscriber group cells that can be down. When notifying the electronic device 105 in the idle mode, the control channel is established between the electronic device 105 and the core network 120 to provide any additional information, for example frequency of the femtocells, physical cell identifier split, and information indicating if the femtocell is an open access cell or a hybrid cell. The notification distinguishes between the closed subscriber group cell, the open access cell and the hybrid cell. In some embodiments, an indication of information associated with the femtocells is included in a message used for the notification. Examples of the indication of information include, but are not limited to, a paging cause within the page message. The paging cause indicates whether the notification is a message for a mobile terminating call, a mobile terminating short message, or an unstructured supplementary service data.

In some embodiments, the message can include one or more bits, for example bits 21 indicate paging for a mobile terminating call, bits 00 indicate paging for a mobile terminating short message, bits 01 indicate paging for an unstructured supplementary service data, and bits 11 is a spare bit used to notify the electronic device 105 of the presence of the femtocells if the electronic device is in a dedicated call. The base station 210 then transmits the message to the electronic device 105.

In some embodiments, the electronic device 105 ignores the notification on absence of the message. The electronic device 105 can further establish a connection with one or more of the femtocells on receiving the notification.

The method stops at step 325.

In the preceding description, the present invention and its advantages have been described with reference to specific embodiments. However, it will be apparent to a person of ordinary skill in the art that various modifications and changes can be made, without departing from the scope of the present invention, as set forth in the claims below. Accordingly, the specification and figures are to be regarded as illustrative examples of the present invention, rather than in restrictive sense. All such possible modifications are intended to be included within the scope of the present invention, as described in the accompanyling claims and their equivalents.

What is claimed is:

1. A method for notifying availability of femtocells to an electronic device, the method comprising:
determining, by a base station of a macrocell, a fingerprint for each of the femtocells;
maintaining, by the base station, fingerprints of the femtocells; and
notifying, by the base station, the availability of the femtocells to the electronic device based on corresponding fingerprints.

2. The method of claim 1, wherein the femtocells are at least one of a closed subscriber group cell, an open access cell, and a hybrid cell.

3. The method of claim 1, wherein determining the fingerprint comprises:
generating the fingerprint of each of the femtocells by the base station.

4. The method of claim 3, further comprising:
reporting the fingerprint in a measurement report by the electronic device to the base station.

5. The method of claim 3, further comprising:
reporting a presence of the femtocells within a range of the macrocell by the electronic device to the base station.

6. The method of claim 1, wherein determining the fingerprint comprises:
extracting the fingerprint from an association between a macro cell identifier and one or more identifiers of one or more femtocells on a home subscriber server (HSS).

7. The method of claim 1, wherein maintaining the fingerprints comprises:
maintaining an association between a macro cell identifier, one or more identifiers of the femtocells.

8. The method of claim, 7 further comprising:
maintaining an association between a femtocell and one or more electronic devices that can access services through the femtocell.

9. The method of claim 1, wherein notifying the availability of the femtocells device comprises:
identifying by the base station that one or more electronic devices that have access rights to one or more femtocells are within a coverage area of the macro cell under which the femtocell fingerprint occurs.

10. The method of claim 1, wherein notifying the electronic device comprises:
notifying the availability of the femtocells using one or more control channels.

11. The method of claim 9, wherein the control channels are at least one of a Slow Dedicated Control CHannel (SDCCH), a Slow Associated Control CHannel (SACCH) and a Packet Associated Control CHannel (PACCH) when the electronic device is in a connected mode.

12. The method of claim 1, wherein notifying, by the base station, the availability of the femtocells to the electronic device comprises:
generating a message including an indication of information associated with the femtocells: and
transmitting the message to the electronic device by the base station.

13. A system for notifying availability of femtocells to an electronic device, the system comprising:
a macrocell;
femtocells in vicinity of the macrocell;
the electronic device that receives notification of the availability of the femtocells; and
a base station for determining a fingerprint for each of the femtocells, maintaining fingerprints of the femtocells, and notifying the availability of the femtocells to the electronic device based on corresponding fingerprints.

14. The system of claim 13, wherein the femtocells are at least one of a closed subscriber group cell, an open access cell, and a hybrid cell.

15. The system of claim 13, wherein the base station generates the fingerprint of each of the femtocells.

16. The system of claim 15, wherein the electronic device reports the fingerprint in a measurement report to the base station.

17. The system of claim 15, wherein the electronic device reports a presence of femtocells within a range of the macrocell by the electronic device to the base station.

18. The system of claim 13, wherein the base station extracts the fingerprint from an association between a macro fingerprint and one or more identifiers of one or more femtocells on a home subscriber server.

19. The system of claim 13, wherein the base station maintains an association between a macro fingerprint and one or more identifiers of the femtocells.

20. The system of claim 19, wherein the base station maintains an association between a femtocell and one or more electronic devices that can access services through the femtocell.

21. The system of claim 13, wherein the base station notifies the availability of the femtocells using one or more control channels.

22. The system of claim 21, wherein the control channels are at least one of a Slow Dedicated Control CHannel (SDCCH), a Slow Associated Control CHannel (SACCH) and a Packet Associated Control CHannel (PACCH) when the electronic device is in a connected mode.

23. The system of claim 13, wherein the base station generates a message including an indication of information associated with the femtocells, and transmits the message to the electronic device.
